(19) United States
(12) Patent Application Publication
(10) Pub. No.: US 2007/0242020 A1
(43) Pub. Date: Oct. 18, 2007

(54) Liquid crystal display device and common voltage generating circuit

(75) Inventor: Takuya Uehara, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/786,783

(22) Filed: Apr. 12, 2007

(30) Foreign Application Priority Data
Apr. 12, 2006 (JP) 2006-109854

(51) Int. Cl. G09G 3/36

(52) U.S. Cl. 345/98

(57) ABSTRACT

A common voltage generating circuit which is provided to an active matrix type liquid crystal display device having a plurality of pixel electrodes, switch elements provided correspondingly to the pixel electrodes and a counter electrode opposed to the pixel electrodes, and generates a common voltage to be applied to the counter electrode. The circuit has an operational amplifier that amplifies a signal for generating a common voltage in a non-inversion manner, and a transistor that amplifies an output from the operational amplifier so as to output the common voltage. An output terminal of the operational amplifier is connected directly to an inversion input terminal not via the transistor so that the operational amplifier is a full-feedback voltage follower.

### BACKGROUND OF THE INVENTION

1. Field of the Invention

The present invention relates to an active matrix type liquid crystal display device having a switch element such as a thin film transistor, and a common voltage generating circuit to be used therein.

2. Description of the Related Art

Active matrix type liquid crystal display devices have opposed two substrates and a liquid crystal layer sealed between these substrates. One substrate has a plurality of pixel electrodes arranged into a matrix pattern, switch elements such as TFTs (Thin Film Transistors) provided correspondingly to the respective pixel electrodes, and signal electrodes and scanning electrodes connected to the switch elements. The other substrate has a counter electrode opposed to the respective pixel electrodes.

In such an active matrix type liquid crystal display device, pixels are formed on portions opposed to the pixel electrodes and the counter electrode. An arrangement direction of liquid crystal particles changes according to a voltage to be applied between the pixel electrodes and the counter electrode, so that light transmittance changes. In this case, a voltage of a video signal to be applied becomes an AC voltage whose polarity changes into a positive or negative state. This is because when a DC voltage is applied between the electrodes, impurities or the like in the liquid crystal layer are concentrated on one electrode, thereby expediting deterioration in the liquid crystal layer. Therefore, the video signal is AC-driven by a frame inversion system where the positive and negative states are inverted per frame.

When the video signal is AC-driven, it is known that a voltage shift occurs in the video signal due to a leak current of the TFT or the like, and positive and negative signal levels of the video signal becomes asymmetrical with respect to a common voltage applied to the counter electrode. When such a voltage shift occurs, a DC component of the shift is applied to the pixels, thereby causing deterioration in the liquid crystal and flicker. In order to correct the voltage shift, therefore, offset adjustment for the common voltage applied to the counter electrode is required, so that the voltage shift should be compensated.

Methods of adjusting the offset include a method using a PWM signal. In this case, a common voltage generating circuit is provided with a rectifying circuit, an operational amplifier and a transistor. The rectifying circuit rectifies a PWM signal. The operational amplifier amplifies an output from the rectifying circuit in a non-inversion manner. The transistor amplifies an output from the operational amplifier so as to output a common voltage. When a duty ratio of the PWM signal is changed, the level of the common voltage output from the transistor can be adjusted. In an actual production line, a worker operates a remote controller or the like so as to change the duty ratio of the PWM signal and adjust the level of the common voltage.

Conventionally, in the above common voltage generating circuit, however, in the case where a noise is mixed into a feedback loop of the operational amplifier, the noise is amplified by the transistor and is further amplified by the operational amplifier so as to be positively fed back. Hence, the operational amplifier oscillates, and the transistor is occasionally broken by an excess oscillation output.

Japanese Patent Application Laid-Open No. 2005-12266 discloses a technique that protects an output transistor against an excess current. However, this technique changes the time from occurrence of abnormality in a load to the OFF-operation of the output transistor according to the level of the abnormality. When the level of the abnormality is high, the output transistor is turned off immediately, and when the level of the abnormality is low, the output transistor is turned off after certain time passes. Therefore, this is not the technique that prevents the above-mentioned breakage of the transistor due to the oscillation of the operational amplifier.

### SUMMARY OF THE INVENTION

It is an object of the present invention to prevent a transistor from being broken due to oscillation of an operational amplifier without providing a special protecting circuit in a common voltage generating circuit to be used in an active matrix type liquid crystal display device.

An active matrix type liquid crystal display device being a premise of the present invention includes: a liquid crystal panel, a common voltage generating circuit and a PWM signal supply unit. The liquid crystal panel has a first substrate and a second substrate. The first substrate is provided with a plurality of pixel electrodes arranged into a matrix pattern, switch elements provided correspondingly to the pixel electrodes, and signal electrodes and scanning electrodes connected to the switch elements, respectively. The second substrate is provided with a counter electrode opposed to the pixel electrodes. A liquid crystal layer is sealed between the first substrate and the second substrate. A common voltage generating circuit generates a common voltage to be applied to the counter electrode of the liquid crystal panel. A PWM signal supply unit that supplies a PWM (Pulse Width Modulation) signal for generating the common voltage. The common voltage generating circuit has a rectifying circuit that rectifies the PWM signal, an operational amplifier that amplifies an output from the rectifying circuit in a non-inversion manner, and a transistor that amplifies an output from the operational amplifier so as to output the common voltage. In such active matrix type liquid crystal display device, the present invention has a feature in which an output terminal of the operational amplifier in the common voltage generating circuit is connected directly to an inversion input terminal thereof without via the transistor so that the operational is a full feedback type voltage follower.

A common voltage generating circuit being a premise of the present invention is provided in an active matrix type liquid crystal display device having a plurality of pixel electrodes arranged into a matrix pattern, switch elements provided correspondingly to the pixel electrodes, signal electrodes and scanning electrodes connected to the switch elements, respectively and a counter electrode opposed to the pixel electrodes, and generates a common voltage to be applied to the counter electrode. The common voltage generating circuit includes: an operational amplifier that amplifies a signal for generating the common voltage in a non-inversion manner; and a transistor that amplifies an output from the operational amplifier so as to output the common voltage. In such common voltage generating circuit, the present invention has a feature in which an output terminal of the operational amplifier is connected directly to an inversion input terminal thereof without via the transistor so that the operational amplifier is a full feedback type voltage follower.

In the present invention, the output terminal of the operational amplifier is connected directly to the inversion input terminal thereof, so that the voltage follower is constituted, and the voltage gain of the operation amplifier becomes 1. For this reason, the output voltage of the operational amplifier becomes equal to the input voltage, so that amplification is not carried out. Since a feedback loop from the output terminal to the inversion input terminal does not include the transistor, even if a noise is mixed into an input of the transistor, the noise is not amplified by the transistor and is not positively fed back to the operational amplifier.

According to the present invention, therefore, even if a special protecting circuit is not provided, breakage of the transistor due to excess oscillation of the operational amplifier can be prevented by a simple means for directly connecting the output terminal of the operational amplifier to the inversion input terminal.

### BRIEF DESCRIPTION OF THE DRAWINGS

FIG. 1 is a diagram illustrating a liquid crystal display device and a common voltage generating circuit according to one embodiment of the present invention;

FIG. 2 is a schematic sectional view illustrating a liquid crystal panel;

FIG. 3 is a diagram illustrating a voltage waveform of a video signal to be applied to a pixel electrode;

FIG. 4 is a diagram illustrating a voltage shift of a video signal; and

FIG. 5 is a diagram illustrating a conventional example.

### DESCRIPTION OF THE PREFERRED EMBODIMENTS

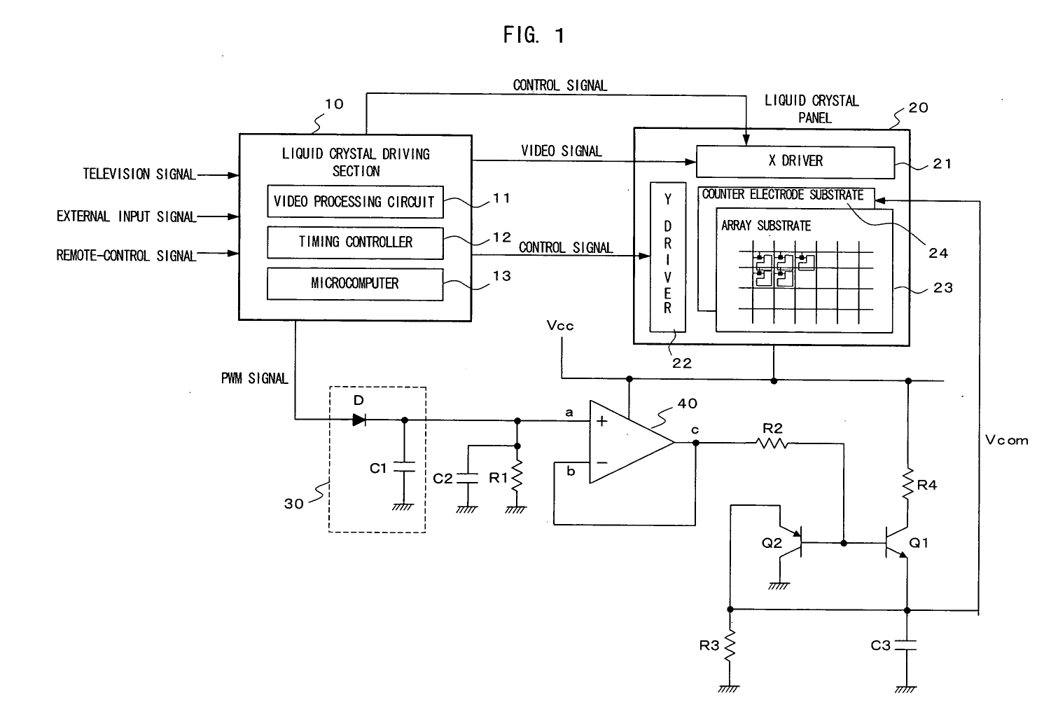

FIG. 1 is a diagram illustrating an active matrix type liquid crystal display device and a common voltage generating circuit according to one embodiment of the present invention. The case where the present invention is applied to a liquid crystal television is described as an example. A liquid crystal driving section 10 which drives a liquid crystal panel 20 is composed of one-chip IC. The one-chip IC contains a video processing circuit 11 that outputs a video signal, a timing controller 12 that outputs a timing signal, and a microcomputer 13 that makes various controls. A television signal, an external input signal, and a remote control signal from a remote controller are input into the liquid crystal driving section 10.

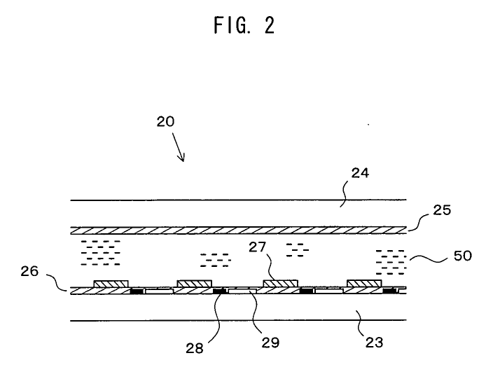

The liquid crystal panel 20 has an X driver (source driver) 21, a Y driver (gate driver) 22, an array substrate 23 and a counter electrode substrate 24. A control signal such as a timing pulse output from the liquid crystal driving section 10 is supplied to the X driver 21 and the Y driver 22. A video signal output from the liquid crystal driving section 10 is supplied to the X driver 21. FIG. 2 is a schematic sectional view of the liquid crystal panel 20. A liquid crystal layer 50 is sealed between the array substrate 23 and the counter electrode substrate 24. Scanning electrodes 26, signal electrodes 27, TFTs (thin film transistors) 28 and pixel electrodes 29 are formed on the array substrate 23. The pixel electrodes 29 are arranged on the substrate into a matrix pattern, and the TFTs 28 are provided correspondingly to the pixel electrodes 29. Drains of the TFTs 28 are connected to the corresponding pixel electrodes 29. The scanning electrodes 26 supply a driving signal from the Y driver 22 to gates of the TFTs 28. The signal electrodes 27 supply a video signal from the X driver 21 to sources of the TFTs 28. A counter electrode 25 opposed to the pixel electrodes 29 of the array substrate 23 are formed on an entire surface of the counter electrode substrate 24. A common voltage, mentioned later, is applied to the counter electrode 25. The X driver 21 supplies the video signal to the pixel electrodes 29 via the TFTs 28 selected by the Y driver 22, and writes the video signal into pixels to be formed on a counter portion between the pixel electrodes 29 and the counter electrode 25.

The array substrate 23 constitutes one embodiment of a first substrate in the present invention, and the counter electrode substrate 24 constitutes one embodiment of a second substrate in the present invention. The liquid crystal driving section 10 constitutes one embodiment of a PWM signal supply unit in the present invention, and the TFTs 28 constitute one embodiment of switch elements in the present invention.

A common voltage generating circuit shown in FIG. 1 is described below. The common voltage generating circuit has a rectifying circuit 30, an operational amplifier 40 and a transistor Q1. The rectifying circuit 30 rectifies a PWM signal supplied from the liquid crystal driving section 10. The operational amplifier 40 amplifies an output from the rectifying circuit 30 in a non-inversion manner. The transistor Q1 amplifies an output from the operational amplifier 40 so as to output a common voltage Vcom. R1 to R4 designate resistors, C1 to C3 designate capacitors, and D designates a diode. The capacitor C1 and the diode D constitute the rectifying circuit 30. A transistor Q2 quickly discharges residual electric charges of the liquid crystal panel 20 when the power of a television is turned OFF, and is not directly related to the present invention.

The operational amplifier 40 is a non-inversion amplifier, and a DC voltage from the rectifying circuit 30 is supplied to its non-inversion input terminal a. An output terminal c of the operational amplifier 40 is connected directly to an inversion input terminal b, and the operational amplifier 40 constitutes a full-feedback type (feedback factor is 100%) voltage follower. Therefore, the voltage gain of the operational amplifier 40 becomes 1, and a voltage which is the same as the input voltage is output to an output terminal c of the operational amplifier 40. When the operational amplifier 40 has such a constitution, the feedback loop from the output terminal c to the inversion input terminal b does not include the transistor Q1.

The output from the operational amplifier 40 is supplied to bases of the transistors Q1 and Q2 via the resistor R2. The transistor Q1 is an NPN type transistor for outputting common voltage, and the transistor Q2 is a PNP type transistor for discharging residual charges. While the television is ON, the transistor Q2 is OFF, and only the transistor Q1 operates. A collector of the transistor Q1 is connected to a DC power supply line Vcc via the resistor R4, and an emitter of the transistor Q1 is grounded via a parallel circuit including the capacitor C3 and the resistor R3. A collector of the transistor Q2 is grounded, and an emitter of the transistor Q2 is connected to the emitter of the transistor Q1.

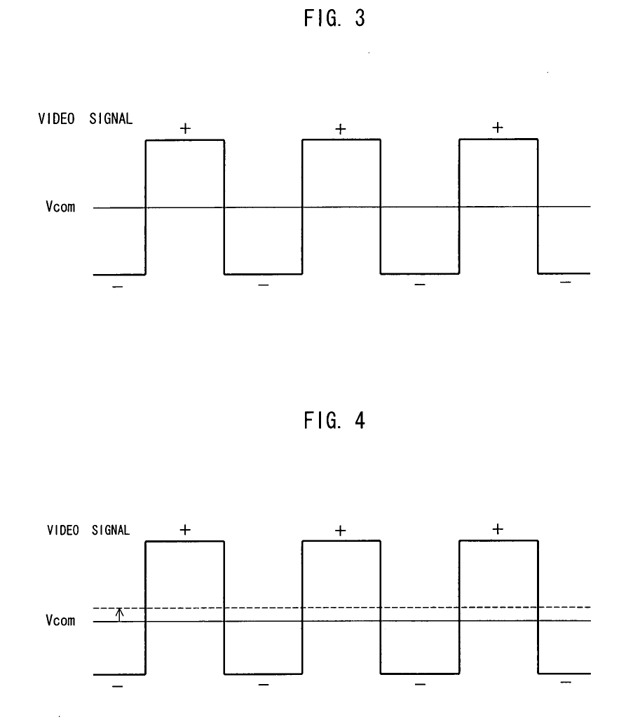

A common voltage Vcom is taken out from the emitter of the transistor Q1 and is supplied to the counter electrode 25 (FIG. 2) of the liquid crystal panel 20. The voltage of the video signal to be applied to the pixel electrodes 29 via the TFTs 28 is an AC voltage having positive and negative polarities with respect to the common voltage Vcom as shown in FIG. 3. As shown in FIG. 3, the positive and negative signal levels of the video signal are originally symmetrical with respect to the common voltage Vcom. However, when a voltage shift occurs in the video signal due to a leak current of the TFTs 28 or the like, the positive and negative signal levels of the video signal become asymmetrical with respect to the common voltage Vcom as shown in FIG. 4. This causes problems such as deterioration in the liquid crystal and flicker. Therefore, in the production line, a worker operates a remote controller so as to change a duty ratio of the PWM signal output from the liquid crystal driving section 10 and adjust the level of the common voltage Vcom. In this case, as shown by a broken line of FIG. 4, the offset is adjusted so that the common voltage Vcom is in the middle of the positive and negative levels of the video signal, namely, the video signal becomes symmetrical with respect to the common voltage Vcom. As a result, the voltage shift of the video signal is compensated.

In the above-described common voltage generating circuit, the output terminal c of the operational amplifier 40 is directly connected to the inversion input terminal b so as to constitute the voltage follower, and the voltage gain of the operational amplifier 40 becomes 1. For this reason, the output voltage from the operation amplifier 40 is equal to the input voltage, and thus amplification is not carried out. Since the feedback loop from the output terminal c to the inversion input terminal b does not include the transistor Q1, even if a noise is mixed into an input (base circuit) of the transistor Q1, the noise is not amplified by the transistor Q1 and is not positively fed back to the operational amplifier 40. Therefore, even if a special protecting circuit is not provided, the breakage of the transistor Q1 due to excess oscillation of the operational amplifier 40 can be prevented by a simple means for directly connecting the output terminal c of the operational amplifier 40 to the inversion input terminal b. Even if a noise is mixed into an input signal of the operational amplifier 40, the noise is not amplified because the operational amplifier 40 is the voltage follower whose voltage gain is 1. Therefore, the level of the noise in the output from the operational amplifier 40 is low, and thus the transistor Q1 is not broken.

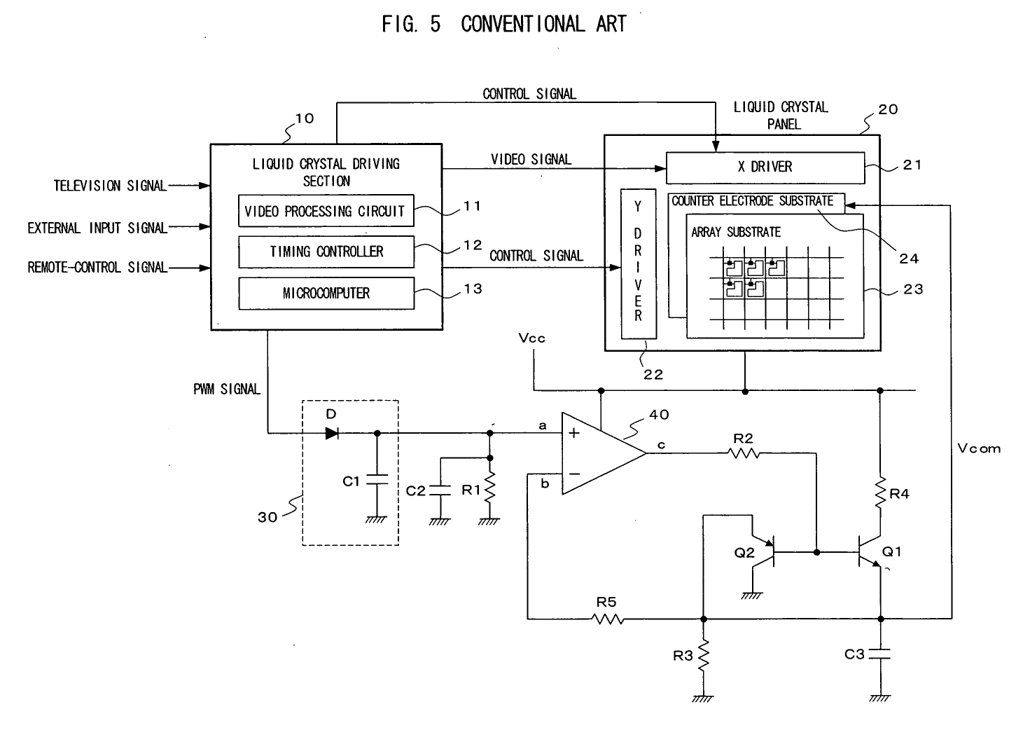

FIG. 5 illustrates one example of the conventional common voltage generating circuit. In FIG. 5, portions same as the portions in FIG. 1 are designated by the same reference numerals. As shown in the drawing, conventionally the feedback loop of the operational amplifier 40 includes the resistor R2, the transistor Q1 and the resistor R5. For this reason, if a noise is mixed into the feedback loop, the noise is amplified by the transistor Q1, and is further amplified by the operational amplifier 40 to be positively fed back. Hence, the operational amplifier 40 is oscillated, and the transistor Q1 is occasionally broken by an excess oscillation output. In the circuit of the present invention shown in FIG. 1, however, the above-mentioned simple means can solve this problem.

In the present invention, besides the above embodiment, various embodiments can be adopted. For example, the above embodiment exemplifies the TFT as the switch element, but the present invention can be also applied to a liquid crystal display device using a TFD (Thin Film Diode) or a MIM (Metal Insulated Metal) type two terminal nonlinear element as the switch element.

In the above embodiment, the level of the common voltage Vcom is adjusted by changing the duty ratio of the PWM signal. Instead of this, the level of the common voltage Vcom may be adjusted by, for example, a variable resistor. In this case, a signal for generating a common voltage to be supplied to the common voltage generating circuit does not have to be a PWM signal, and may be a simple DC voltage.

The above embodiment exemplifies the case where the present invention is applied to the liquid crystal television, but the present invention can also be applied to personal computers and various displays other than the liquid crystal televisions.

What is claimed is:

1. An active matrix type liquid crystal display device, comprising:
a liquid crystal panel that has,
a first substrate having a plurality of pixel electrodes arranged into a matrix pattern, switch elements provided correspondingly to the pixel electrodes, and signal electrodes and scanning electrodes connected to the switch elements, respectively,
a second substrate that is provided with a counter electrode opposed to the pixel electrodes, and
a liquid crystal layer sealed between the first substrate and the second substrate;
a common voltage generating circuit that generates a common voltage to be applied to the counter electrode of the liquid crystal panel; and
a PWM signal supply unit that supplies a PWM (Pulse Width Modulation) signal for generating the common voltage,
said common voltage generating circuit having a rectifying circuit that rectifies the PWM signal, an operational amplifier that amplifies an output from the rectifying circuit in a non-inversion manner, and a transistor that amplifies an output from the operational amplifier so as to output the common voltage,
wherein an output terminal of the operational amplifier is connected directly to an inversion input terminal thereof without via the transistor so that the operational amplifier is a full feedback type voltage follower.

2. A common voltage generating circuit that is provided for an active matrix type liquid crystal display device having a plurality of pixel electrodes arranged into a matrix pattern, switch elements provided correspondingly to the pixel electrodes, signal electrodes and scanning electrodes connected to the switch elements, respectively and a counter electrode opposed to the pixel electrodes, and that generates a common voltage to be applied to the counter electrode, the circuit comprising:
an operational amplifier that amplifies a signal for generating the common voltage in a non-inversion manner; and
a transistor that amplifies an output from the operational amplifier so as to output the common voltage,
wherein an output terminal of the operational amplifier is connected directly to an inversion input terminal thereof without via the transistor so that the operational amplifier is a full feedback type voltage follower.
